(19) United States
(12) Patent Application Publication
(10) Pub. No.: US 2003/0022550 A1
(43) Pub. Date: Jan. 30, 2003

(54) Clasp for prong of an electric plug to detect prior use

(76) Inventor: Paul D. Chowdhury, Fremont, CA (US)

Correspondence Address: Robert Samuel Smith, 1263 Emory St., San Jose, CA, 95126, US

(21) Appl. No.: 09/777,775

(22) Filed: Feb. 5, 2001

(51) Int. Cl. H01R 3/00

(52) U.S. Cl. 439/488

(57) ABSTRACT

A clasp attachable to the prongs of an electric plug for aiding a provider or user of an appliance to determine that the appliance has been tampered with or used by plugging the electrical plug into a socket. The clasp, once attached, can only be removed by rupturing the clasp. In one embodiment, the clasp is a clamshell construction into which the prong is inserted. Once inserted, the prong can only be withdrawn by rupturing the clasp. In another embodiment, the clasp includes a pair of channels connected by a thin strap. Each channel slides onto one of the prongs. In both embodiments, the clasp is locked in position by engagement of a stud with existing apertures in the prongs.

### FIELD OF THE INVENTION

This invention relates to a sheath secured over the prongs of an electrical plug whose removal indicates prior use of the device to which it is attached, . . .

### BACKGROUND AND INFORMATION DISCLOSURE

Domestic marketing of electrical appliances particularly for the home has one enormous expense that is borne by OEMs (Original Equipment Manufacturers) or passed on to the buying public. Many customers have developed the practice of not really deciding that they want to buy an item until the item is brought home and “tried out” for a day, a week, a month or longer. The item has become worn or defective because of misuse.

When the item is returned, it is supposed not to have been used. The customer may claim that the item has never been used. Nevertheless, in order to maintain its reputation with the next customer who purchases the item, the store must undergo the expense of a thorough examination and replacement of parts where required. This requirement substantially diminishes any profit otherwise realized from the sale of the item.

In a related scenario, the typical customer would welcome proof that his/her purchased item has not been previously returned

Disclosures have appeared related to shielding prongs of the plugs on the end of a cord for an appliance and are intended for safety purposes, such as to prevent small children from inserting the plug into a “hot” receptacle.

For example, U.S. Pat. No. 5,055,057 to Boyer discloses a locking device for attachment to the male electric plug on the power supply line. The device is removable from the plug by unlocking the locking device with a key.

U.S. Pat. No. 4,740,169 to Gordon discloses a cover or protector combined with a cleaner that protects the prongs from corrosion and accumulation of dirt.

U.S. Pat. No. 5,342,212 to Francis discloses a funnel shaped protector that shields the area where the wire is connected to the plug.

U.S. Pat. No. 4,305,634 to Lewis discloses a disk guard that prevents the users fingers from contacting the exposed prongs when the prongs are partially inserted into a receptacle.

U.S. Pat. No. 4,420,2723 to Bloomingdale discloses a metal clip that is insertable through the bores in the ends of the prongs of a plug to prevent inserting the plug into a female receptacle. The clip prevents small children from inserting the plug into a female socket.

None of these devices are intended for nor can they be adapted to the purposes of the present invention.

### SUMMARY OF THE INVENTION

It is an object of this invention to assist store personnel or OEM's in determining that an electrical appliance having a power cord with a plug on a free end has or has not been used.

This invention is directed toward an enclosure split into two sections wherein the two sections are joined by a living hinge. The enclosure is attached to a plug by positioning one prong into the enclosure and snapping the two sections together. The enclosure is locked onto the prong by a stud that engages an aperture in the prong thereby capturing the prong inside the enclosure. A pull tab extends from one of the sections and is accessible for stripping the enclosure off the prong. A weak (thin) area of the enclosure provides that the enclosure will rupture when stripped from the prong. Rupturing the enclosure renders the enclosure incapable of being mounted back onto the prong.

A store owner whose policy is not to accept returned used appliances, is enabled to determine that the item has been used simply by observing the presence or absence of the enclosure on the prong of the plug.

### BRIEF DESCRIPTION OF THE FIGURES

FIG. 1 shows the enclosure of the invention.

FIG. 2 shows the enclosure of this invention ready for snapping onto the prong of a plug.

FIG. 3 shows the sections of the invention folded together and snapped onto the prong of the plug.

FIG. 4 shows another embodiment of the invention.

FIG. 5 shows the embodiment of FIG. 4 laid out.

FIG. 6 shows the clasp mounted on a plug.

FIG. 7 is a sectional view of the embodiment of FIG. 4.

FIGS. 8A and 8B shows another embodiment comprising a rod through the apertures.

FIG. 9 shows and embodiment in which the guard is a container.

### DESCRIPTION OF A BEST MODE

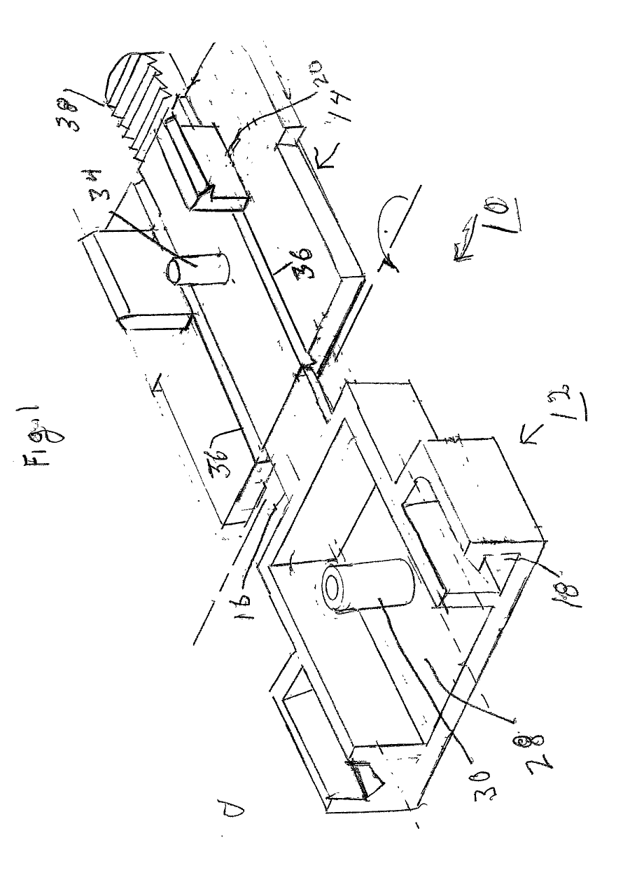

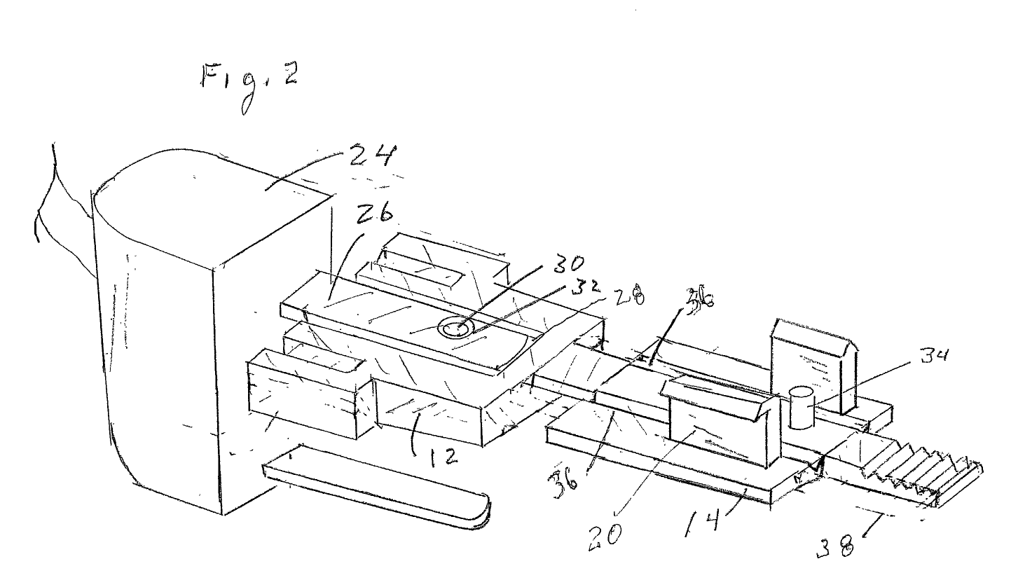

Turning now to a discussion of the drawings, FIG. 1 is a perspective view showing the clasp 10 of this invention in the unfolded state. The clasp 10 is an enclosure comprising one clasp section 12 secured to another clasp section 14 by a living hinge 16. One clasp section 12 has the female clasp member 18 and the other section 14 has the male clasp member 20 of the clasp 10 that snaps together when clasp section 14 is folded about hinge 16 into engagement with clasp section 12, providing that a prong of a plug is positionable through an opening into the enclosure. (clasp 10) as shown in FIG. 3.

FIG. 2 shows an electric plug 24 of the type to which the enclosure of this invention is to be attached. The typical plug 24 has a pair of prongs 26. Each prong 26 has an aperture 32. Each aperture 32 engages a spring contact (not shown) when the prongs are inserted into a female receptacle (not shown). Engagement of the spring contact and apertures provide that moderate force is required to disconnect the plug from the receptacle.

In FIG. 2, one prong 26 is engaged with one clasp section 12. of the clasp 10 The prong 26 is positioned in a groove 28 formed by adjacent female clasp member 18 in section 12.

FIG. 3 shows the two clasp sections 12, 14 snapped together onto prong 26. Prong 26 is shown in FIG. 2 but is concealed in FIG. 3.

Section 12 has a female stud 30 positioned to extend through an aperture 32 in prong 26. Male stud 34 engages female stud 30 when the clasp two sections, 12 and 14, are folded together as shown in FIG. 3. The male stud 34, engaged with the female stud 30 through aperture 32, prevents the enclosure from sliding off prong 26 after the two clasp sections 12 and 14 are snapped together.

Referring to FIG. 3, in order to remove the clasp 10 from the plug 24, the user grasps the pull tab 38 so as to peel the clasp 10 off prong 26. Section 14 has a pair of grooves 36 providing that when tab 38 is pulled, the clasp 10 will rupture along grooves 36 thereby preventing reuse of the clasp 10.

The general principle of the invention is a clasp that snaps onto the prong of a plug and can only be disengaged from the plug by destroying the clasp. Variations and modifications of the invention may be prompted by reading the specification and studying the drawings which are within the scope of the invention.

For example, in FIGS. 4, 5, 6, 7 there is shown another embodiment of the invention in which the clasp encloses both prongs.

FIG. 4 is a perspective view of a second embodiment of a clasp 13 of this invention positioned for sliding onto both prongs 26.

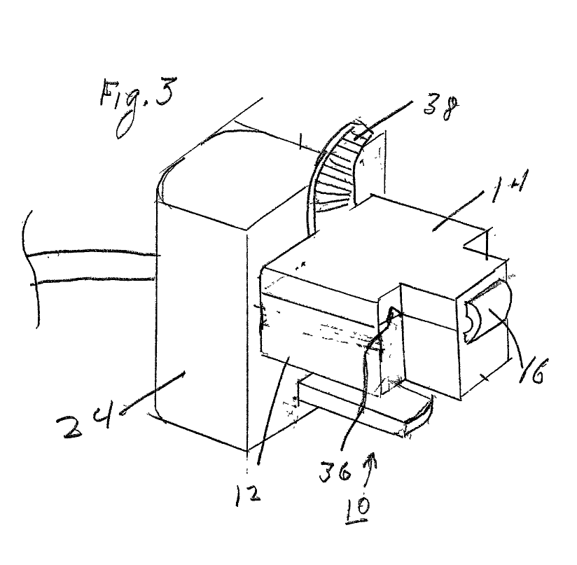

FIG. 5 shows the clasp 13 stretched out for more detailed examination.

There are shown two channel sections, 120A and 120B, connected by a live hinge 122.

Each channel section, 120A, 120B includes two side panels 121 and a connecting panel 123 with a lip 128 along the outside edge of the side panels that retains each channel 120 A,B on the respective prong 26.

The clasp is preferably injection molded of a flexible material, a plastic such as polyethylene, polypropylene, polyvinyl chloride, urethane or neoprene..

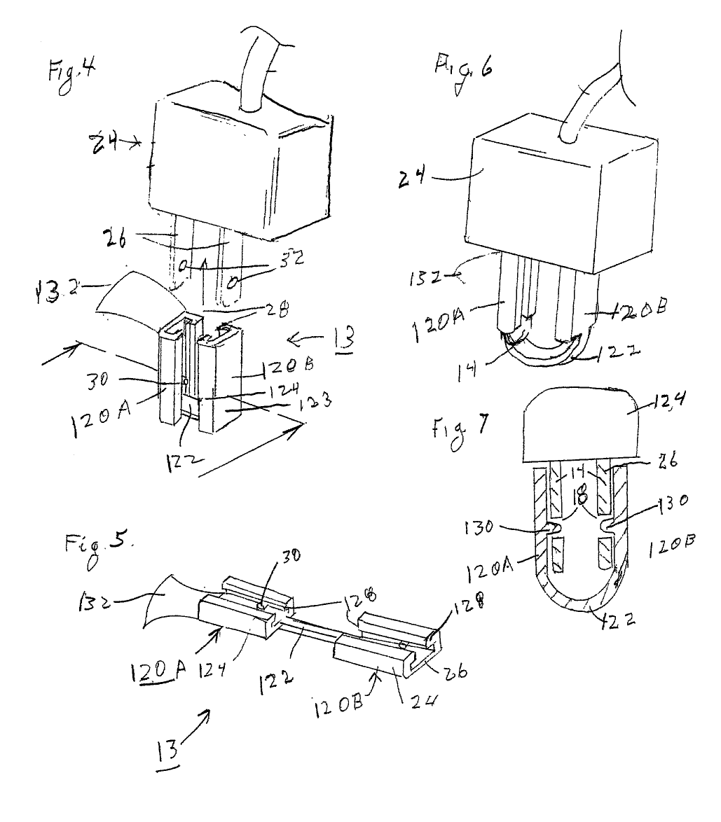

FIGS. 6 is a perspective view and FIG. 7 is a sectional view showing the clasp of this second embodiment of the invention mounted on both prongs of the plug.

Each channel 120 A,B has a stub 130 that engages the aperture 32 of the prong 26 when the channel 120 A,B is slid onto the prong 26 thereby locking the channel 120A, B onto the prong 26. .

FIG. 7 is a sectional view showing each channel 120 A, B in position on its respective prong 26. The stub 130 of each channel 120A,B has engaged the respective aperture.

In another embodiment, (not shown) the side panels 20 of each channel are made of a material having a flexibility operably selected to permit biasing toward one another so that the prong is clamped between side members of the channel.

Also shown in FIGS. 4-6 is a tab 132 attached to an end of one of the channels. . When it is required to strip off the clasp preparatory to inserting the plug into the receptacle, the user grasps the tab and pulls. This action strips off the clasp which ruptures the link.

The appliance is delivered to the customer with the clasp mounted on the plug so that, if the appliance is returned with the sheath removed, then this provides irrefutable evidence that the the user has used or tampered with the appliance further providing the store owner with a basis for refusing to accept the returned appliance.

Once the device has been mounted on the prongs, it is possible to determine that the device has been removed preparatory to use even though the user attempts to mount the device back onto the prongs.

If the policy of the store is to refuse acceptance of a used appliance, then a ruptured sheath can serve as a basis for refusing the returned merchandise.

In a similar situation, if the company practice is to separate returned appliances into one group which requires no servicing and a second group that must be examined for possible repair requirements, then a returned appliance with the sheath removed or ruptured would be returned to the second group.

Other variations and modifications of the invention within the scope of the invention may be considered according to which the clasp is a guard mounted on the plug presents evidence of use of an electric plug when the guard is broken or removed.

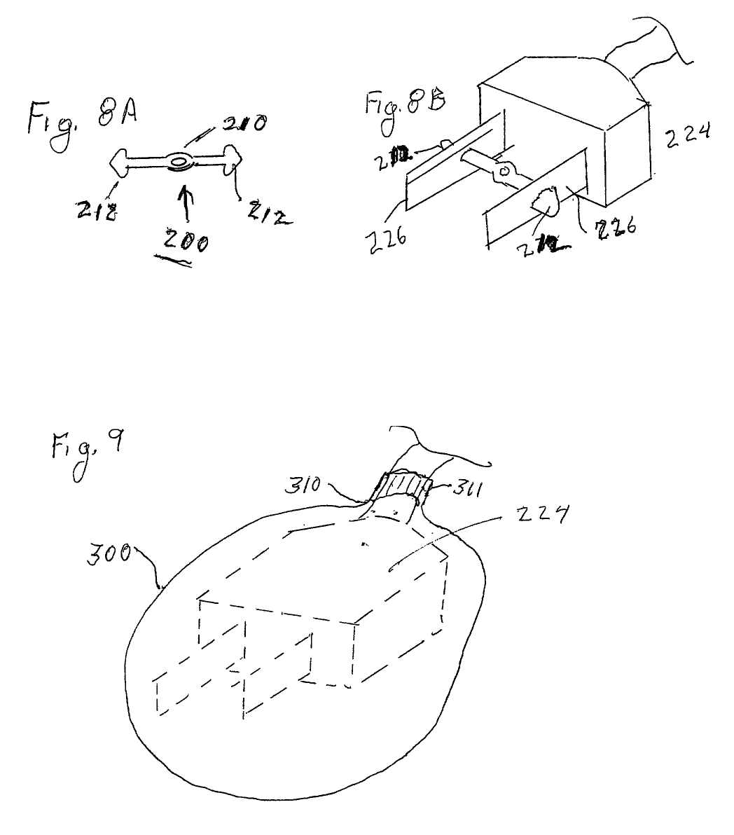

FIG. 8A shows an embodiment in which the guard consists of a rod 200 with weakened section 210 and a pair of knobs 212. As shown in FIG. 8B, the rod 200 extends through apertures in both prongs 226 and prevents insertion of the prongs into a receptacle. A knob on each end of the rod 200 requires that the rod must be broken in order to remove the rod from the prongs, preparatory to using the plug.

FIG. 9 shows another embodiment in which the guard is a container 300 with an opening 310 defined by a neck. the plug 224 is positioned inside the container 300 with the cord extending through the opening and out of the container. A band 311 with adhesive on one side is wrapped around the neck so that the container must be ruptured in order to insert the plug into a receptacle.

In view of the more than one embodiments of this invention within the scope of the invention. I therefore wish to define the scope of my invention by the appended claims.

I claim:

1. A clasp, for enclosing at least one prong of a pair of prongs of an electric plug, comprising:
one clasp section (12);
another clasp section (14);
a living hinge (16) joining said one clasp section (12) to said another clasp section (14);
means (18, 20) for clipping said one clasp section (12) to said another clasp section (14);
said one clasp section (12), another clasp section (14), living hinge (16) and means for clipping arranged to form an enclosure with an opening to permit enclosing said at least one prong;
means (30, 34) for retaining said at least one prong in said enclosure;

2. The clasp of claim 1 wherein said means for clipping comprises:
a female clasp member (18) mounted on said one clasp section (12):
a male clasp member ((20) mounted on said another clasp section (14);
said male and female clasp members arranged to snap together when clasp section (14) is folded about hinge (16) into engagement with clasp section (12).

3. The clasp of claim 1 wherein each one of said at least one prong has an aperture (32) and said means (30, 34) for retaining comprises:
a stud means for extending through said aperture when said at least one prong is positioned in said enclosure.

4. The clasp of claim 2 wherein said at least one prong is one prong and said clasp is arranged to snap onto said at least one prong.

5. The clasp of claim 4 wherein said stud means comprises a female stud (30) positioned on an inside surface of said one clasp section (12) and a male stud (34) positioned on an inside surface of said another clasp section (14).

6. The clasp of claim 4 comprising a pull tab on at least one of said one clasp section and said another clasp section arranged to permit a user to tear said channel from said prong by grasping and pulling said at least one tab.

7. The clasp of claim 1 wherein at least one of said one clasp section and said another clasp section has a weakened area arranged to rupture when an attempt is made to separate said clasp from said at least one prong.

8. A clasp for enclosing a prong of an electric plug, , said prong having an aperture, said clasp comprising:
one clasp section (12);
another clasp section (14);
a living hinge (16) joining said one clasp section (12) to said another clasp section (14);
a female clasp member (18) mounted on said one clasp section (12):
a male clasp member ((20) mounted on said another clasp section (14);
said male and female clasp members arranged to snap together when clasp section (14) is folded about hinge (16) into engagement with clasp section (12).
said one clasp section (12), another clasp section (14), living hinge (16) and means for clipping arranged to form an enclosure with an opening to permit enclosing said at least one prong;
a female stud (30) positioned on an inside surface of said one clasp section (12) and a male stud (34) positioned on an inside surface of said another clasp section (14) arranged for extending through said aperture when said prong is positioned in said enclosure.
a pull tab on at least one of said one clasp section and said another clasp section arranged to permit a user to tear said channel from said prong by grasping and pulling said at least one tab.
at least one of said one clasp section and said another clasp section having a weakened area arranged to rupture when an attempt is made to separate said clasp from said at least one prong.

9. The clasp of claim 1 wherein said plug has two prongs and said clasp is engagable with both said two prongs, said one clasp section and said another clasp section each comprising:
a channel having a pair of side panels joined by a joining panel and operably shaped to permit slideable engagement of said one channel onto one prong of said two prongs;
another channel having a pair of side panels joined by a joining panel and operably shaped to permit slideable engagement of said another channel onto another prong of said two prongs;
said living hinge connected to an end of said one channel and to an end of said said another channel;
said living hinge being sufficiently weak to provide that said link will break when said one section and said another section are engaged with said respective prongs and any one of said one section and said another section is then disengaged from said respective prong.

10. The clasp of claim 9 wherein said means for clipping comprises means for locking each one of said channels onto said respective prong.

11. The clasp of claim 10 wherein said means for retaining comprises said one channel and said another channel being made of elastomeric material and biased to clamp onto said respective prong.

12. The clasp of claim 10 wherein at least one of said prongs has a surface with an aperture and said means for retaining comprises:
a stud on a surface of at least one of said joining panels of said one one channel and said another channel;
said stud operably arranged to engage said aperture when said channel is slid onto said respective prong.

13. The clasp of claim 9 wherein at least one side panel of said channel has a groove operably arranged to provide that an edge of said respective prong engages said groove when said sheath is slid onto said respective prong.

14. The sheath of claim 9 wherein said sheath is made of a plastic having an operable flexibility selected to enable said channel to clamp on said prong.

15. The sheath of claim 1 wherein said sheath is made of a plastic selected from a group of plastics that includes polyethylene, polyvinyl chloride, polyvinyl propylene and urethane.

16. A guard for presenting evidence of use of an electric plug having at least two prongs with an aperture in at least one of said at least two prongs, wherein one of breakage and removal of said guard from said prongs indicates that the electric plug has been used, said guard comprising:
means attachable to said plug and adapted for preventing insertion of prongs of said plug into a plug receptacle;
a lock member, arranged in operable combination with said means for preventing, to lock said means for preventing onto said plug;
said lock means arranged in operable combination with said means for preventing to provide that said guard be destroyed by separating said guard from said plug suggesting that said plug has been used.

17. The guard of claim 16 wherein said at least one aperture is an aperture in both prongs and said guard comprises:
said means for preventing is a rod extending through both said apertures;
said lock member comprises a pair knob, each end of said rod having one of said knobs on an end of said rod providing that when said rod extends through both said apertures with each knob abutting a face of one of said two prongs facing away from said other prong, it is necessary to break said rod in order to remove said rod preparatory to insertion of said prongs into a plug receptacle.

18. The guard of claim 16 wherein:
said means for preventing is a container having an opening defined by a neck dimensioned for positioning said plug in said container with a cord attached to said plug extending out of said container;
said lock member is a band with adhesive on one side and wrapped snuggly around said neck and cord providing that, in order to plug into a receptacle, said band must be ruptured.
